(19) United States
(12) Patent Application Publication
(10) Pub. No.: US 2019/0303456 A1
(43) Pub. Date: Oct. 3, 2019

(54) DATA SYNCHRONIZATION AND METHODS OF USE THEREOF

(71) Applicant: Honda Motor Co., LTD., Tokyo (JP)

(72) Inventor: Vanda LIM, Marysville, OH (US)

(21) Appl. No.: 15/938,687

(22) Filed: Mar. 28, 2018

(51) Int. Cl. G06F 17/30

(52) U.S. Cl. CPC G06F 17/30174; G06F 17/3084; G06F 17/30849

(57) ABSTRACT

A system, method, and apparatus for displaying performance characteristics of a device. The method may include accessing a database of data log files from a data storage source, wherein the data log files may include at least one of a data input and a data output from a device. The method may further include accessing a database of video files comprising at least one video feed that includes an image of the device. The database of video files and data log files may be synchronized with respect to time and may be represented via a graphical user interface using multiple timeline graphical representations of video feed and data log files. The timeline graphical representations may be represented in parallel on the graphical user interface. The graphical user interface may further include a scroll element, to enable contemporaneous scrolling of the timeline graphical representations.

### FIELD OF THE INVENTION

The present disclosure relates to methods and systems for viewing data related to automation systems in an industrial environment.

### BACKGROUND

Most modern automation systems rely heavily on industrial controllers. Industrial controllers may include any one of or a combination of a Programmable Logic Controller (PLC), a Programmable Logic Relay (PLR), a Programmable Controller, a Distributed Control System (DCS), and other known automation controllers. Industrial controllers may store and execute user-defined parameters to effect decisions during a process. Industrial controllers may have various programming functions that may include ladder logic, structured text, function block diagramming, instruction lists, and sequential flow charts, for example. As one example, most modern manufacturing processes rely heavily on PLCs to control sequential and combinatorial logic in industrial processes. PLCs may be used to control aspects of industrial processes such as those involving assembly lines and robotic devices, for example. Depending on the scale of the industrial application, industrial automation devices can generate a significant amount of real time data. For example, machine health data, alarm statuses, operational statistics, electrical loads, mechanical loads, and operator interaction may be monitored and/or recorded continually during testing and during the manufacturing process.

The abovementioned data may be stored in a computer memory and stored in a database, for example. The data may be stored for a variety of reasons, some examples of which may include: monitoring of machine health, analysis for improving efficiency, scheduling maintenance operations, monitoring of production output, troubleshooting, and determining the cause of faults and/or crashes. Because the amount of real time data may be significant, an operator may view the collection of data via a user interface to improve review efficiency. For example, a user interface may be configured so as to allow the operator to select a particular collection of data and to view expanded data elements. The user interface may further allow an operator to view a collection of data from a particular time interval for various components to troubleshoot the individual components separately and/or to analyze the interaction among various components. While the abovementioned method may improve an operator's ability analyze a significant amount of data, it may be still be difficult and inefficient to determine a frame of reference over which an error, fault, or crash occurred when troubleshooting, even when using the abovementioned user interface. Further, it may be necessary analyze the effect of external factors on the manufacturing process. Therefore, a further need exists to simplify the viewing and analysis of large collections of data. Further advantages will become apparent from the disclosure provided below.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

In accordance with one aspect, a method for displaying performance characteristics of a device is disclosed. The method may include accessing a database of data log files from a data storage source, wherein the data log files include at least one of a data input and a data output from a device. The method may further include accessing a database of video files comprising at least one video feed that includes an image of the device. The database of video files and data log files may be synchronized with respect to time and represented via a graphical user interface as a first timeline graphical representation of the at least one video feed and a second timeline graphical representation of data log files. The first and second timeline graphical representations may be represented in parallel on the graphical user interface. The graphical user interface may further include a scroll element. In response to a scroll command, for example, the first timeline graphical representation and the second timeline graphical representation may be contemporaneously scrolled.

In accordance with another aspect of the disclosure, a non-transitory computer readable medium having instructions stored therein is disclosed. When the instructions are executed by one or more processors, the instructions cause the one or more processors to access a database of data log files from a data storage source, wherein the data log files include at least one of a data input and a data output from a device and/or a string of commands to be executed, and/or recording or log files related to a string of commands. The processor(s) further access a database of video files comprising at least one video feed, including an image of the device, and synchronize the database of the video files and the data log files with respect to time. The processor(s) may generate a first timeline graphical representation of the at least one video feed and a second timeline graphical representation of data log files, wherein the graphical representations include a scroll element. The processor may further display the first timeline graphical representation and the second timeline graphical representation in parallel, via a graphical user interface (GUI) on a display device; and in response to a scroll command, contemporaneously scroll the first timeline graphical representation and the second timeline graphical representation.

In accordance with another aspect of the disclosure, a system for processing and displaying performance characteristics of a device is disclosed. The system comprises at least one memory element that stores instructions for executing a process for displaying performance characteristics of the device and at least one processor configured to execute the process. The process may include accessing a database of data log files from a data storage source, wherein the data log files include at least one of a data input, a data output, a string of commands to be executed, or a recording or log file of a string of commands for a device. The process may further include accessing a database of video files comprising at least one video feed that includes an image of the device. The database of video files and data log files may be synchronized with respect to time and represented via a graphical user interface as a first timeline graphical representation of the at least one video feed and a second timeline graphical representation of data log files. The first and second timeline graphical representations may be represented in parallel on the graphical user interface. The graphical user interface may further include a scroll element. In response to a scroll command, the first timeline graphical representation and the second timeline graphical representation may be simultaneously scrolled.

Additional advantages and novel features of these aspects will be set forth in part in the description that follows, and in part will become more apparent to those skilled in the art upon examination of the following or upon learning by practice of the disclosure.

### BRIEF DESCRIPTION OF THE DRAWINGS

The novel features believed to be characteristic of aspects of the disclosure are set forth in the appended claims. In the description that follows, like parts are marked throughout the specification and drawings with the same numerals, respectively. The drawing figures are not necessarily drawn to scale and certain figures may be shown in exaggerated or generalized form in the interest of clarity and conciseness. The disclosure itself, however, as well as a preferred mode of use, further objects and advantages thereof, will be best understood by reference to the following detailed description of illustrative aspects of the disclosure when read in conjunction with the accompanying drawings, wherein:

FIG. 1 is a high level diagram in accordance with an aspect of the disclosure;

FIG. 2 is a block diagram in accordance with an aspect of the disclosure;

FIG. 3 is a block diagram in accordance with an aspect of the disclosure;

FIG. 4 is an example of a user interface in accordance with an aspect of the disclosure;

FIG. 5 illustrates an example computer system for an electronic system in accordance with an aspect of the disclosure;

FIG. 6 is an example microcontroller in accordance with an aspect of the disclosure; and

FIG. 7 is a block diagram of various example system components according to one aspect of the disclosure.

### DETAILED DESCRIPTION

The following includes definitions of selected terms employed herein. The definitions include various examples and/or forms of components that fall within the scope of a term and that may be used for implementation. The examples are not intended to be limiting.

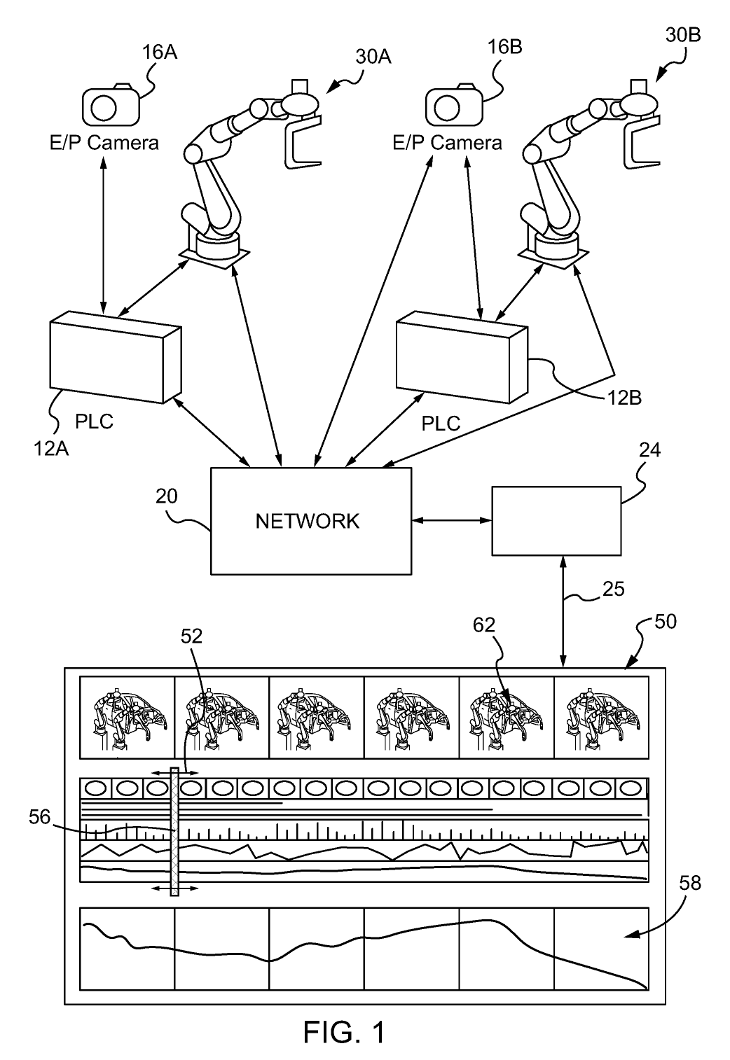

FIG. 1 is a high level graphical representation of one aspect of the disclosure. In an industrial environment, several input output devices (I/O devices), which may, for example, be or include Programmable Logic Controllers (PLC)s 12A and 12B, may be used to control operation of a plurality of industrial devices. An example of an industrial device is shown in FIG. 1 as welding robots 30A and 30B. The PLCs and welding robots may be coupled to a network 20 which is further explained in detail below. It is noted that while welding robots 30A and 30B are shown FIG. 1 and may be discussed throughout the specification, any type of automated system or industrial device may be usable with the current disclosure and may be interchangeably referred to as a robot. For example, a robot may include any one of or a combination of a conveyor, robot arm, or other material handler, a welding apparatus, a sealant application apparatus, a paint application apparatus, a computer numerical control (“CNC”) apparatus and/or any type of automated or semi-automated machine usable in an industrial environment. A series of cameras (e.g., 16A and 16B) may be configured so that any one of the welding robots 30A and/or 30B are within the field of view of the cameras 16A and/or 16B. The cameras 16A and 16B may be configured to store a video stream locally and/or may provide a video stream to network 20. A data processing device 24 may be configured to synchronize stored data relating to the PLCs 12A and/or 12B, the robots 30A and/or 30B, and the cameras 16A and/or 16B. The processing device 24 may be coupled to a display device to display a graphical user interface (GUI) 50.

As discussed in further detail below, the data processing application may synchronize multiple stored sources of video and/or audio data with respect to time. Further, the data processing application may synchronize any one of or plurality of the data sources mentioned above with respect to time. Depending on the data to be displayed and the nature of the video and/or audio data, the processing device may scale the data such that relevant data is synchronized with a corresponding video frame. For example, when a robot is not moving or idle, very little data may be generated, whereas when a robot is performing tasks and/or movements, a larger amount of data may be produced. Thus, in the abovementioned example, the data corresponding with the device may be scaled, such that a larger amount of data is shown at once during an operational period of an apparatus. Thus, the amount of device data that corresponds with a single or multiple frames of video of the device may scaled, such that all relevant data with respect to the particular video frame may be displayed.

The synchronized data may be provided via the GUI and represented in a timeline format having a cursor 56 that may be scrollable by a user in directions 52, and where the timeline may include a plurality of video feeds, which may comprise a series of individual scrollable video frames that represent the respective frame of each stored video feed from cameras 16A and 16B with respect to time. The system and GUI may be scalable, and thus any number of video feeds may be added either by default or as configured by a user. Each video feed may be expanded into a larger window 62, which may represent a frame of a video feed at a time corresponding to a position of the cursor/scroll element 56, for example. A user may be able to scroll along the timeline by controlling a cursor and/or scroll element 56. A scrolling function may occur by a user using conventional pointing device (e.g., a mouse) and clicking and dragging the scrod element 56, for example, in either direction 52. As another example, a scrolling function may occur by keystroke (e.g., by pressing arrow keys on a keyboard), or by turning a designated scroll wheel. Further, for example, the GUI may be displayed on a touch sensitive display and may initiate a scrod command based on a user touching and/or dragging scroll element 56 in either direction 56. In addition, a user may be able to move the cursor 56 to a particular video frame, and may be able to selectively play the video feed from the particular time corresponding with the scrod element 56. Thus, a user may be able to play a video feed as it occurred live based on the position of the cursor 56. Further, while the timeline in FIG. 1 is illustrated in a horizontal configuration, any suitable positional configuration may be implemented. For example, the timeline may be oriented vertically.

The timeline may further include any number of data feeds. Each data feed may include, for example, a simplified version of recorded data with respect to that data source and/or may include all data recorded with respect to the corresponding data source. For example, an enlarged series of windows 58 may be configured to show a ladder logic that corresponds to output programming and/or output of data from either one of PLCs 12A and/or 12B for example. Accordingly, in the simplified version of the GUI 50 shown in FIG. 1, a user may scroll cursor 56 and may view a video feed 62 and the ladder logic and/or data 58 corresponding with a particular frame and/or portion of video. A user may then scroll to advance both the video feed and the ladder logic and/or data associated with the video feed.

Aspects of the disclosure discussed below may enable significant improvement in the efficiency of troubleshooting operations for a facility. For example, in a traditional facility a significant amount of data may be stored, and while data may be timestamped or organized in some other way, the volume of data may make it difficult to determine what may have caused an error during an operation, for example. Further, in traditional schemes, it may be difficult to determine if an error during a manufacturing process and/or test run was due to an error in programming, an error in hardware, and/or an unexpected outside occurrence (e.g., a person Interfering with the operation of the process). By implementing the aspects of the disclosure discussed herein, a user may determine exactly when an a particular operation and/or error occurred by scrolling through the stored video feed and may then view all time synchronized data and/or programming associated with the industrial device at the time the operation and/or error occurred. A user may also be able to play, pause, and/or rewind a video feed and/or a data stream at the speed at which it occurred and/or at a faster or slower speed to assist in determining the exact root cause of an identified problem.

Once the cause of an problem is determined, a user and/or software may correct any design, engineered, and/or human issues, for example. Further, potential design and/or engineering flaws may be determined and corrected. In addition, by implementing the systems mentioned throughout, best practices in troubleshooting may be identified and shared amongst multiple facilities, for example, to quickly track down errors and make modifications to equipment, systems, and/or programming from known root cause problems. In other aspects, recorded and synchronized data may be utilized for training purposes. Additional aspects, implementations, and advantages will become apparent to one of ordinary skill in the art upon review of the example implementations of the disclosure discussed in detail below.

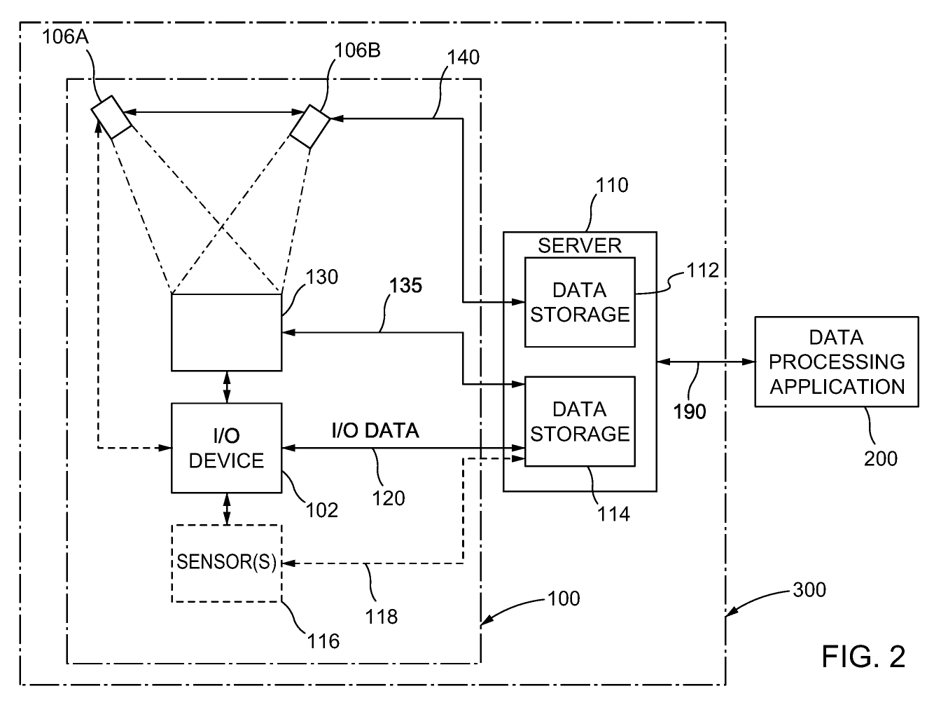

As shown in FIG. 2, an industrial facility may include a single or plurality of output system(s) 100. An output system 100 may include an input-output device (I/O device) 102, and/or an industrial device 130, which may be or include, for example, any device and/or component of an industrial process that is capable of transmitting and/or receiving data, and that may be in the field of view of a camera 106A and/or a second camera 1066. It is noted that, while two cameras are shown in the example shown in FIG. 2, any suitable number of cameras may be employed. A camera may include any known apparatus having an image sensor and/or other capability for capturing data representative of an image. The cameras may be positioned to record any portion of the manufacturing process, for example, that may include the actions of an industrial device 130. One example implementation of the abovementioned system includes a camera or multiple cameras set up to record a welding robot as an industrial device 130 during a production process. Several cameras may be positioned in different locations in relation to the industrial device, such as to allow multiple views while troubleshooting, as discussed further below. It is noted that the camera configuration shown in FIG. 2 is only an example and various implementations may include any known configuration. For example, as an alternative, one camera may be configured with a field of view covering multiple robots, while another camera may have a limited field of view limited to a single robot. Further, each camera may be capable of panning, tilting, and zooming, for example, to change the field of view of the camera. As another example a 360 degree camera may be implemented to allow a larger field of view.

The input-output section (I/O device) 102 may include a series of sensors, and/or other devices that may be configured to detect the occurrence of an event and/or to constantly or intermittently record data, for example. The I/O source 102 may also include a single or multiple PLCs that are programmed to operate manufacturing processes via user-designed logic programs or user programs, for example. The abovementioned PLCs may be used to coordinate the action(s) of a single or multiple industrial devices. Industrial devices may include, but are not limited to, robots, conveyors, pumps, fans, ovens, filters, alarms, fixtures and/or safety fixtures, for example. In each of the abovementioned PLCs, user programs may be stored in memory and generally executed by the PLC in a sequential manner as is known in the art. Examples of such programs include, but are not limited to, sequentially executed instructions, instruction jumping, looping, and interrupt routines. Associated with the user program may be a plurality of memory elements or variables that provide dynamics to PLC operations and programs. These variables may be user-defined, for example, and may be defined as bits, bytes, words, integers, floating point numbers, timers, counters and/or other data types to name but a few examples. Each PLC may output data to a storage device and/or may be coupled to a data logger and/or may include data logging functions. Each PLC may communicate via known protocols, that include but are not limited to: Ethernet IP, Devicenet, Modbus TCP, and Profinet. Further, an input-output section may provide a string of commands or execute software that provides a string of commands to operate at least one or any combination of manufacturing processes discussed above.

As one example, each I/O device (e.g., a PLC) may output a data stream 120 to a storage element 114. The storage element 114 may include a hard drive or other known storage element within a data server 110, for example, as shown in FIG. 2. Further, the cameras 106A and 106B may record visual and/or audio data and transmit the data via data stream 140 to a storage element 112 within a data server 110. It is noted that, while only industrial device 130 and I/O device 102 as sources are shown in FIG. 2 for simplicity purposes, the system may be scalable and include any number of industrial devices and/or I/O devices within a single manufacturing facility or over multiple manufacturing facilities. Further, any number of sensors(s) 116 may also provide data via data stream 118 to storage element 114. For example, a vibration sensor and/or sensors may be configured to detect vibration of the industrial device 130. It is noted that the abovementioned example is not limiting, and as discussed below, the data may be stored using any suitable method and/or device or system known in the art.

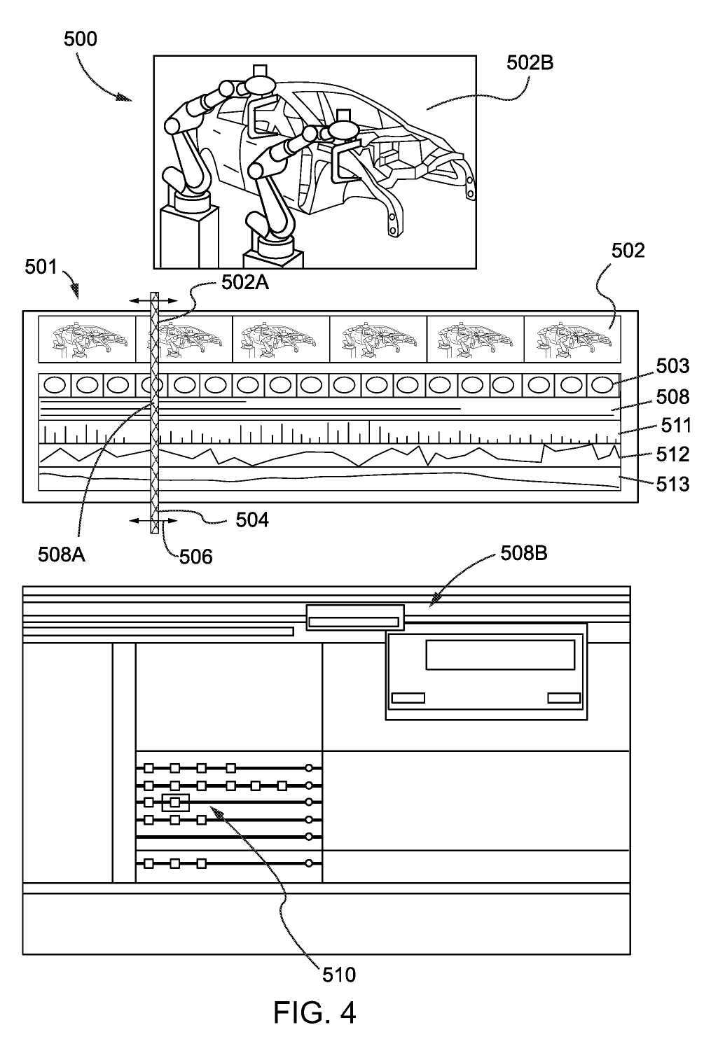

As shown in FIG. 2, one example implementation of the disclosure includes an I/O device that may be configured to communicate with a data server apparatus 110. Another example include a device that may be configured to execute a string of commands to be executed. The data server apparatus 110 and the Industrial data source 102 may be coupled to one another in a manner enabling bidirectional communications through, for example, the communication path 120. Further, the sensor 116, and cameras 106A and 106B may be coupled to the data server, thereby allowing bidirectional communication therewith. The industrial data source 102, cameras 106A-B, and/or sensor 116A may produce data that is stored in the data server apparatus 110. In one example, the server 110 may store camera data 112 and industrial data 114 with along with reference data for time. For example, data received via data streams 120, 135, and/or 118 may be stored along with corresponding time information for each data entry. Similarly, visual and/or audio data received via data stream 140 may be stored along with time data corresponding thereto. A data processing application 200, that is discussed in detail below, may be coupled to the server in a manner enabling bidirectional communication through communication path 190, for example. As discussed further below, the data processing application may synchronize the video and/or audio data received from data stream 140 with the data received from each of data streams 120, 135, and/or 118 in order to present a user with an interface that allows contemporaneous scrolling (e.g., via a cursor) of data streams with video and/or audio streams, for example. The user interface is further discussed below with reference to FIG. 4.

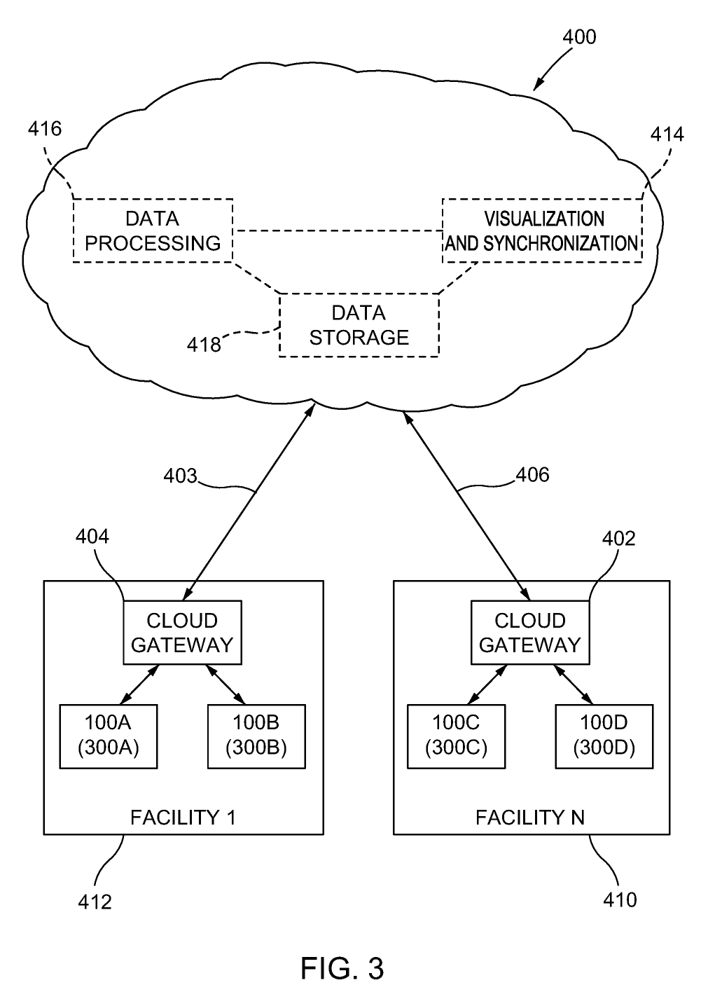

As shown in FIG. 3, cloud based services may be used to implement one or more aspects of the disclosure. One or more industrial facilities 410 and/or 412 may include a number of automation systems (e.g., example such systems 100 and/or 300 being shown in FIG. 2). Each of the automation systems 100A, 100B, 100C, and/or 100D may include a single or plurality of the systems discussed above with reference to FIG. 2. According to one or more embodiments of this disclosure, automation systems 100A, 1008, 100C, and/or 100D may communicate with a cloud platform to leverage cloud-based applications. That is, the automation systems 100A, 1008, 100C, and/or 100D may be configured to discover and interact with cloud-based computing services 400 hosted by cloud platform. A cloud platform may Include any suitable infrastructure that allows shared computing services (e.g., 414, 416, 418) to be accessed and utilized by cloud-capable devices. The cloud platform may comprise a public cloud accessible via the Internet by devices having Internet connectivity and appropriate authorizations to utilize the services, for example. Alternatively, the cloud may comprise a private cloud operated internally by the enterprise, for example. An example private cloud can comprise a set of servers hosting cloud services and residing on a corporate network protected by a firewall.

Cloud services may include, but are not limited to, data storage 418, data processing 416, control applications (e.g., applications that can generate and deliver control instructions to automation systems 100A, 1008, 100C, and/or 100D based on analysis of real-time system data or other factors), visualization applications 414 (e.g., for generating a GUI and/or for scaling a graphical representation of data with respect to a video feed), reporting applications, notification services, and/or other such applications. For example, in a cloud based system, data storage from either of data storage(s) 112, 114 may be cloud based. Further, in another aspect that may be used in combination with the abovementioned aspects, at least one automation system may include local storage (e.g., as shown by reference 300 In FIG. 2). Accordingly, the cloud service may function to provide data processing and visualization, for example, while storage of data may occur at one or more of automation system 300A, 300B, 3000, and/or 300D. As another alternative, each automation system may include local storage, while a cloud service 400 may be implemented to archive data and/or to store processed data, for example.

If the cloud platform is a web-based cloud, industrial devices 100A, 1008, 100C, and/or 100D at the respective industrial facilities 412 and 410 may, for example, interact with cloud services 400 via the Internet. In an example configuration, automation systems 100A, 1008, 100C, and/or 100D may access the cloud services 400 through separate cloud gateways 404 and 402 at the respective industrial facilities 412 and 410, where the automation systems 100A, 1008, 100C, and/or 100D connect to the cloud gateways 404 and 402 through a physical, wireless local area network, and/or radio link. In another example configuration, the industrial devices may access the cloud platform directly using an integrated cloud interface.

Providing automation systems with cloud capability may offer a number of advantages particular to industrial automation. For example, cloud-based storage offered by the cloud platform may be easily scaled. Moreover, multiple industrial facilities at different geographical locations may migrate their respective automation data to the cloud for aggregation, collation, collective analysis, and enterprise-level reporting, without the need to establish a private network among the facilities. Automation systems 100A, 1008, 100C, and/or 100D having smart configuration capability, for example, may be configured to automatically detect and communicate with the cloud platform 400 upon installation at any facility, simplifying integration with existing cloud-based data storage, analysis, or reporting applications used by the enterprise. In another example implementation, cloud-based diagnostic applications may monitor the health of respective automation systems and/or their associated industrial devices across an entire plant, or across multiple industrial facilities (e.g., Faculty N, shown as reference 410) that make up an enterprise. The cloud platform may allow software vendors to provide software as a service, removing the burden of software maintenance, upgrade, and backup from customers. It is noted that while two facilities are shown in FIG. 3, it is understood that the current disclosure is applicable to any number of facilities. These industrial cloud computing applications are only intended to be examples, and the systems and methods described herein are not limited to these particular implementations,

The data processing applications 200 and/or 416 may be configured to display a graphical user interface (GUI) showing image information along the lines shown in FIG. 4, for example. As noted above, the data processing application may synchronize multiple stored sources of video and/or audio data with respect to time. Further, the data processing application may synchronize any one of or plurality of the data sources mentioned above with respect to time and/or other parameters. The synchronized data may be provided via a GUI and may be represented in a timeline format 501 for example; the timeline may include a plurality of video feeds 502 and/or 503, which may include a series of individual scrollable video frames that represent the respective frame of each stored video feed with respect to time. It is noted that, while only two scrollable video feeds are shown in FIG. 4, any suitable number of video feeds may be added either by default or as configured by a user. Each video feed may be selectively expanded into a larger window 502B, for example, which may represent a frame of video feed 502 at a time corresponding to a position of the cursor or scrod element 504. A user may be able to scroll along the timeline 501 by controlling scroll element 504 in either direction 506, such as to selectively expend any of the frames in the feeds 502, 503.

A scrolling function may occur by a user using conventional pointing/selecting device (e.g., a mouse) and clicking and dragging the scroll element 504 in either direction 506. As another example, a scrolling function may occur by keystroke (e.g., by pressing arrow keys on a keyboard), and/or by turning a designated scroll wheel. Further, the GUI may be displayed on a touch sensitive display and may initiate a scroll command based on a user touching and/or dragging scroll element 504, for example, in either direction 506. While the timeline 501 in FIG. 4 is illustrated in a horizontal configuration, any suitable positional configuration may be implemented. For example, the timeline 501 may alternatively be oriented vertically.

Further, a user may be provided with the capability to move the scroll element 504 to a particular video frame, and may be able to select to play the video feed from the particular time corresponding with the cursor. For example, a user may be able to play a video feed as it occurs live. Further, a user may be able to view a video feed at a rate that is decreased with relation to time (e.g., in slow motion) and/or at a rate that is increased with relation to time (e.g., in fast motion). A user may also be provided with the option to rewind the feed in any one of the abovementioned states. While only a single enlarged video feed 502B is shown in FIG. 4, a user may be able to select any number of enlarged video feeds and may be able to contemporaneously view each video feed represented in the timeline 501, for example.

Each video feed may be expanded into a larger windows 62 that may display a frame of a video feed at a time corresponding to a position of the cursor/scroll element 56. A user may be able to select to scroll along the timeline by controlling a cursor and/or scroll element 56, for example. A scrolling function may occur by a user using a conventional pointing device (e.g., a mouse) to move the cursor and select and “drag” the scroll element 56 in either direction 52. As another example, a scrolling function may be selected by use of a keystroke (e.g., by pressing one or more arrow keys on a keyboard), or by turning a designated scroll wheel. Further, the GUI may alternatively be displayed on a touch sensitive display, and the user may have the option to select to initiate a scroll command based on the user touching with the cursor and/or dragging the scroll element 56 in either direction 52. Further, a user may be provided with the option to select to move the cursor 56 to a particular video frame, and may be able to play the video feed from the particular time corresponding with the location of the scroll element 56. Thus, for example, a user may thereby be able to play a video feed as it occurs live based on the position of the cursor 56. Further, while the timeline in FIG. 1 is illustrated in a horizontal configuration, any suitable positional configuration may be implemented. For example, the timeline may alternatively be oriented vertically.

The timeline 501 may further include any suitable number of data feeds 508, 511, 512, and/or 513. Each data feed may include a simplified version of recorded data with respect to that data source and/or may include all data recorded with respect to the corresponding data source. In the example shown in FIG. 4, a window 508B shows a ladder logic 510 that corresponds to output programming and/or output of data from a single PLC or multiple PLCs at a particular time 508A, represented by scrod element 504. Accordingly, in the simplified version of the GUI shown in FIG. 4, a user may move a scroll element 504 to selectively view portions of a video feed 502B, along with the ladder logic end/or other data corresponding to a particular frame and/or portion of video. A user may then move the scrod element 504 to advance the video feed, along with the ladder logic and/or data associated with the video feed.

While the scroll element 504 is represented as a line in FIG. 4, a scroll element may include any type of graphical feature that represents a particular point and/or frame along the timeline. For example, a scroll element may be dragable along the timeline 501, and once a position is selected the frame corresponding with the position of the scroll element may be displayed, as discussed throughout, a video feed 502B may then be played from a time represented by the location of the scroll element 504 along the timeline 501. In some instances the scroll element may represent a stationary line or graphical element that denotes a position along timeline 501; however, the timeline 501 may scroll in response to a scroll command and the scroll element 504 may remain stationary.

implementing the above-mentioned cursor significantly improves efficiency of troubleshooting operations, as a user may more easily and readily determine exactly when an a particular operation and/or error occurred by scrolling through the stored video feed and then viewing any selected time synchronized data and/or programming associated with the industrial device at the time the operation and/or error occurred, for example. Further, the data processing application may be configured do display only relevant data that pertains to a particular data feed or a particular video and/or audio feed. For example, window 502 may be set by the user to selectively display a single or multiple views of a robot arm during a manufacturing process. A window 508B or a plurality of windows may be selected to only show data that is relevant to the particular robot arm being displayed in window 502B; this selection may also be set to occur automatically, for example. Accordingly, if the ladder logic for a particular robot is selected to be displayed, the processing application may be configured to only provide video feeds in window 502B that show the particular robot that is controlled by the ladder logic shown in window 508B.

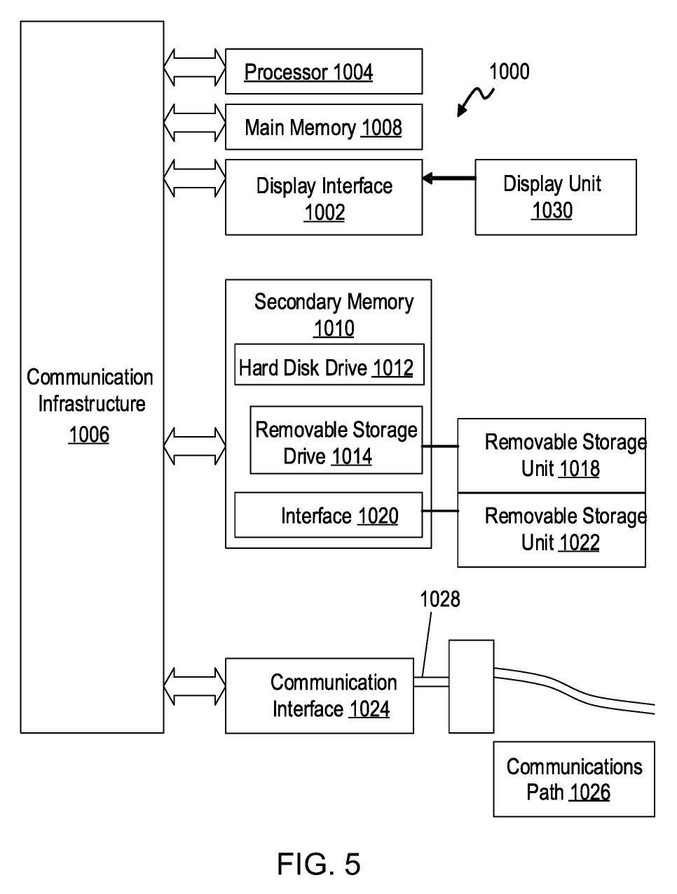

The abovementioned synchronization and GUI may be implemented using hardware, software, or a combination thereof and may be implemented in one or more computer systems or other processing systems. In an aspect of the present invention, features are directed toward one or more computer systems capable of carrying out the functionality of the data processing disclosed above. An example of such a computer system 1000 is shown in FIG. 5.

Computer system 1000 includes one or more processors, such as processor 1004. The processor 1004 is connected to a communication infrastructure 1006 (e.g., a communications bus, cross-over bar, or network). Various software aspects are described in terms of this example computer system. After reading this description, it will become apparent to a person skilled in the relevant art(s) how to implement aspects of the invention using other computer systems and/or architectures.

Computer system 1000 may include a display interface 1002 that forwards graphics, text, and other data from the communication infrastructure 1006 (or from a frame buffer not shown) for display on a display unit 1030. Computer system 1000 also includes a main memory 1008, preferably random access memory (RAM), and may also include a secondary memory 1010. The secondary memory 1010 may include, for example, a hard disk drive 1012, and/or a removable storage drive 1014, representing a floppy disk drive, a magnetic tape drive, an optical disk drive, a universal serial bus (USB) flash drive, etc. The removable storage drive 1014 reads from and/or writes to a removable storage unit 1018 in a well-known manner. Removable storage unit 1018 represents a floppy disk, magnetic tape, optical disk, USB flash drive etc., that is read by and written to removable storage drive 1014. As will be appreciated, the removable storage unit 1018 includes a computer usable storage medium having stored therein computer software and/or data.

Alternative aspects of the present invention may include secondary memory 1010 and may include other similar devices for allowing computer programs or other instructions to be loaded into computer system 1000. Such devices may include, for example, a removable storage unit 1022 and an interface 1020. Examples of such may include a program cartridge and cartridge interface (such as that found in video game devices), a removable memory chip (such as an erasable programmable read only memory (EPROM), or programmable read only memory (PROM)) and associated socket, and other removable storage units 1022 and interfaces 1020, that allow software and data to be transferred from the removable storage unit 1022 to computer system 1000.

Computer system 1000 may also include a communications interface 1024. Communications interface 1024 allows software and data to be transferred between computer system 1000 and external devices. Examples of communications interface 1024 may include a modem, a network interface (such as an Ethernet card), a communications port, a Personal Computer Memory Card International Association (PCMCIA) slot and card, etc. Software and data transferred via communications interface 1024 are in the form of signals 1028, which may be electronic, electromagnetic, optical or other signals capable of being received by communications interface 1024. These signals 1028 are provided to communications interface 1024 via a communications path (e.g., channel) 1026. This path 1026 carries signals 1028 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 1018, a hard disk installed in hard disk drive 1012, and signals 1028. These computer program products provide software to the computer system 1000. Aspects of the present invention are directed to such computer program products.

Computer programs (also referred to as computer control logic) are stored in main memory 1008 and/or secondary memory 1010. Computer programs may also be received via communications interface 1024. Such computer programs, when executed, enable the computer system 1000 to perform the features in accordance with aspects of the present invention, as discussed herein. In particular, the computer programs, when executed, enable the processor 1004 to perform the features in accordance with aspects of the present invention. Accordingly, such computer programs represent controllers of the computer system 1000.

In an aspect of the present invention where the invention is implemented using software, the software may be stored in a computer program product and loaded into computer system 1000 using removable storage drive 1014, hard drive 1012, or communications interface 1020. The control logic (software), when executed by the processor 1004, causes the processor 1004 to perform the functions described herein. In another aspect of the present invention, the system is implemented primarily in hardware using, for example, hardware components, such as application specific integrated circuits (ASICs).

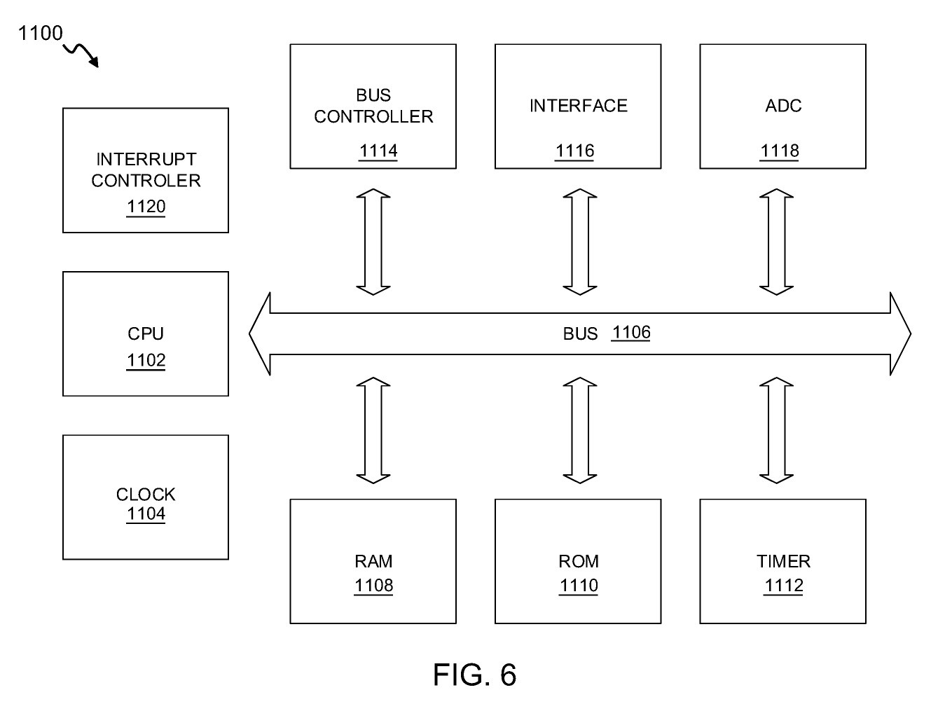

In some implementations, one or more microcontrollers may be implemented in the external device 128 for carrying out features of the present invention. An example of such a microcontroller 1100 is shown in FIG. 6. The microcontroller 1100 includes a CPU 1102, RAM 1108, ROM 1110, a timer 1112, a BUS controller, an interface 1114, and an analog-to-digital converter (ADC) 1118 interconnected via an on board BUS 1106.

The CPU 1102 may be implemented as one or more single core or multi-core processors, and receive signals from an interrupt controller 1120 and a clock 1104. The clock 1104 sets the operating frequency of the entire microcontroller 1100 and may include one or more crystal oscillators having predetermined frequencies. Alternatively, the clock 1104 may receive an external clock signal. The interrupt controller 1120 may also send interrupt signals to the CPU to suspend CPU operations. The interrupt controller 1120 may transmit an interrupt signal to the CPU when an event requires immediate CPU attention.

The RAM 1108 may include one or more SRAM, DRAM, SDRAM, DDR SDRAM, DRRAM or other suitable volatile memory. The ROM 1110 may include one or more PROM, EPROM, EEPROM, flash memory, or other types of non-volatile memory.

The timer 1112 may keep time and/or calculate the amount of time between events occurring within the microcontroller 1100, count the number of events, and/or generate baud rate for communication transfer. The BUS controller 1114 prioritizes BUS usage within the microcontroller 1100. The ADC 1118 allows the microcontroller 1100 to send out pulses to signal other devices.

The interface 1116 is an input/output device that allows the microcontroller 1100 to exchange information with other devices. In some implementations, the interface 1116 may include one or more parallel port, a serial port, or other computer interfaces.

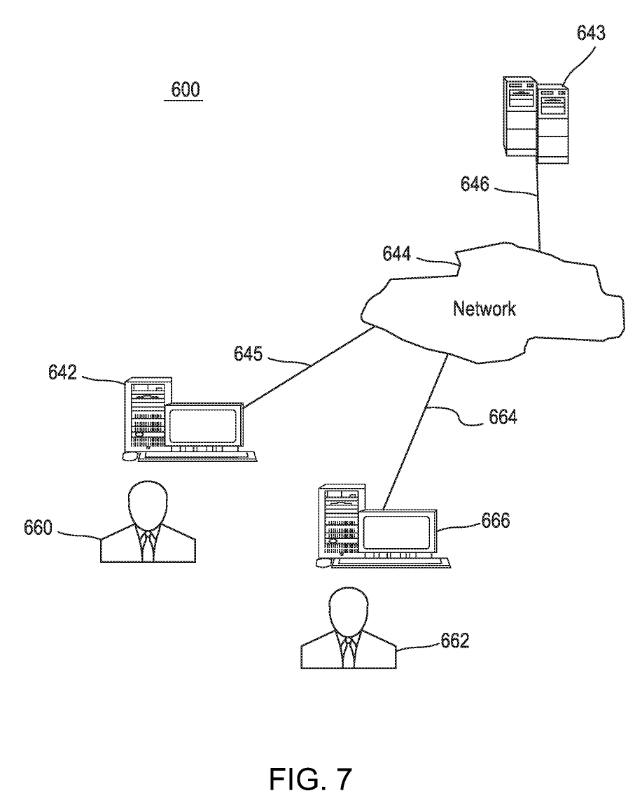

FIG. 7 is a block diagram of various example system components, in accordance with an aspect. FIG. 7 shows a communication system 600 usable in accordance with aspects described herein. The communication system 600 includes one or more accessors 660, 662 (also referred to interchangeably herein as one or more “users”) and one or more terminals 642, 666. For example, terminals 642, 666 can include the data processing application 200 or a related system. In one aspect, data for use in accordance with aspects described herein is, for example, input and/or accessed by accessors 660, 662 via terminals 642, 666, such as personal computers (PCs), minicomputers, mainframe computers, microcomputers, telephonic devices, or wireless devices, such as personal digital assistants (“PDAs”) or a hand-held wireless devices coupled to a server 643, such as a PC, minicomputer, mainframe computer, microcomputer, or other device having a processor and a repository for data and/or connection to a repository for data, via, for example, a network 644, such as the Internet or an intranet, and couplings 645, 646, 664. The couplings 645, 646, 664 include, for example, wired, wireless, or fiberoptic links. In another example variation, the method and system in accordance with aspects described herein operate in a stand-alone environment, such as on a single terminal.

The aspects discussed herein can also be described and implemented in the context of computer-readable storage medium storing computer-executable instructions. Computer-readable storage media includes computer storage media and communication media. For example, flash memory drives, digital versatile discs (DVDs), compact discs (CDs), floppy disks, and tape cassettes. Computer-readable storage media can include volatile and nonvolatile, removable and non-removable media implemented in any method or technology for storage of information such as computer readable instructions, data structures, modules or other data.

The foregoing description of various aspects and examples have been presented for purposes of illustration and description. It is not intended to be exhaustive nor to limit the disclosure to the forms described. The embodiment(s) illustrated in the figures can, in some instances, be understood to be shown to scale for illustrative purposes. Numerous modifications are possible in light of the above teachings, including a combination of the abovementioned aspects. Some of those modifications have been discussed and others will be understood by those skilled in the art. The various aspects were chosen and described in order to best illustrate the principles of the present disclosure and various aspects as are suited to the particular use contemplated. The scope of the present disclosure is, of course, not limited to the examples or aspects set forth herein, but can be employed in any number of applications and equivalent devices by those of ordinary skill in the art. Rather, it is hereby intended the scope be defined by the claims appended hereto.

What is claimed is:

1. A computer-implemented method of displaying performance characteristics of a device comprising:
accessing a database of data log files from a data storage source, wherein the data log files include at least one of a data input and a data output from the device;
accessing a database of video files comprising at least one video feed including an image of the device;
synchronizing the database of the video files and the data log files with respect to time;
generating a first timeline graphical representation of the at least one video feed;
generating a second timeline graphical representation of data log files, wherein the graphical representations include a scroll element;
displaying the first timeline graphical representation and the second timeline graphical representation in parallel on a display device; and
in response to receipt of a scroll command, contemporaneously scrolling the first timeline graphical representation and the second timeline graphical representation.

2. The computer-implemented method of displaying performance characteristics of a device of claim 1, wherein the timeline graphical representation of the at least one video feed includes a series of individual video frames.

3. The computer-implemented method of displaying performance characteristics of a device of claim 2, wherein generating the second timeline graphical representation of data log files further comprises:
scaling the data log files, so that in response to a scroll command, the graphical representation of the data log files correlates with each video frame corresponding to a position of the scroll element.

4. The computer-implemented method of displaying performance characteristics of a device of claim 3, further comprising:
displaying a plurality of windows, wherein at least a first one of the plurality of windows is configured to display an enlarged view of a video frame corresponding with the location of the scroll element, and wherein a second one of the plurality of windows is configured to display at least a portion of the data log files.

5. The method of analyzing data of claim 3, wherein the data log files comprise ladder logic.

6. The method of analyzing data of claim 3, wherein the data log files comprise data output from at least one sensor.

7. The method of analyzing data of claim 1, wherein the at least one of a data input and a data output from the device comprises a string of commands executed by the device.

8. A non-transitory computer readable medium having instructions stored therein that, when executed by one or more processors, cause the one or more processors to:
access a database of data log files from a data storage source, wherein the data log files include at least one of a data input and a data output from a device;
access a database of video files comprising at least one video feed including an image of the device;
synchronize the database of the video files and the data log files with respect to time;
generate a first timeline graphical representation of the at least one video feed;
generate a second timeline graphical representation of data log files, wherein the graphical representations include a scroll element;
display the first timeline graphical representation and the second timeline graphical representation in parallel, via a graphical user interface (GUI) on a display device; and
in response to receipt of a scroll command, contemporaneously scroll the first timeline graphical representation and the second timeline graphical representation.

9. The non-transitory computer readable medium of claim 8, wherein the timeline graphical representation of the at least one video feed includes a series of individual video frames.

10. The non-transitory computer readable medium of claim 9, wherein generating the second timeline graphical representation of data log files further comprises:
scaling the data log files, so that in response to a scroll command, the graphical representation of the data log files correlates with each video frame corresponding to a position of the scroll element.

11. The non-transitory computer readable medium of claim 10, wherein the GUI further comprises a plurality of windows, wherein at least one of a first one of the plurality of windows displays an enlarged view of a video frame corresponding with the location of the scroll element, wherein a second one of the plurality of windows displays at least a portion of the data log files.

12. The non-transitory computer readable medium of claim 10, wherein the data log files comprise ladder logic.

13. The non-transitory computer readable medium of claim 10, wherein the data log files comprise a data output from at least one sensor.

14. The non-transitory computer readable medium of claim 8, wherein the at least one of a data input and a data output from the device comprises a string of commands executed by the device.

15. A system for processing and displaying performance characteristics of a device comprising:
at least one memory element that stores instructions for executing a process for displaying performance characteristics of the device;
at least one processor configured to execute the process, wherein the process comprises:
accessing a database of data log files from a data storage source, wherein the data log files include at least one of a data input and a data output from a device;
accessing a database of video files comprising at least one video feed including an image of the device;
synchronizing the database of the video files and the data log files with respect to time;
generating a first timeline graphical representation of the at least one video feed;
generating a second timeline graphical representation of data log files, wherein the graphical representations include a scroll element;
displaying the first timeline graphical representation and the second timeline graphical representation in parallel on a display device; and in response receipt of a scroll command, contemporaneously scrolling the first timeline graphical representation and the second timeline graphical representation.

16. The system for processing and displaying performance characteristics of a device of claim 15, wherein the timeline graphical representation of the at least one video feed includes a series of individual video frames.

17. The system for processing and displaying performance characteristics of a device of claim 15, wherein generating the second timeline graphical representation of data log files further comprises:
scaling the data log files, so that in response to a scroll command, the graphical representation of the data log files correlates with each video frame corresponding to a position of the scroll element.

18. The system for processing and displaying performance characteristics of a device of claim 17, further comprising displaying a plurality of windows, wherein at least a first one of the plurality of windows is configured to display an enlarged view of a video frame corresponding with the location of the scroll element, and wherein a second one of the plurality of windows is configured to display at least a portion of the data log files.

19. The system for processing and displaying performance characteristics of a device of claim 17, wherein the data log files comprise ladder logic.

20. The system for processing and displaying performance characteristics of a device of claim 17, wherein the data log files comprise data output from at least one sensor.

21. The system for processing and displaying performance characteristics of a device of claim 17, wherein the at least one of a data input and a data output from the device comprises a string of commands executed by the device.
